(19) United States
(12) Patent Application Publication
(10) Pub. No.: US 2017/0262832 A1
(43) Pub. Date: Sep. 14, 2017

(54) Systems and Methods for Use in Facilitating Payment Account Transactions

(71) Applicant: MASTERCARD INTERNATIONAL INCORPORATED, Purchase, NY (US)

(72) Inventors: Rahul A. Deshpande, Chesterfield, MO (US); Matthew R. Stocke, Glendale, MO (US); Jeffrey Allen Cox, O'Fallon, MO (US); Stewart J. Boling, Maryland Heights, MO (US); Nevada Alpine Kent, V, St. Louis, MO (US); Neeraj Javiya, St. Charles, MO (US); Nitin Shambhu, Dublin (IE)

(21) Appl. No.: 15/454,502

(22) Filed: Mar. 9, 2017

Related U.S. Application Data
(60) Provisional application No. 62/306,020, filed on Mar. 9, 2016.

(51) Int. Cl. G06Q 20/22; G06Q 20/32

(52) U.S. Cl. CPC G06Q 20/223; G06Q 20/3278; G06Q 20/3276

(57) ABSTRACT

Systems and methods are provided for use in facilitating payment account transactions, through consumer communication devices, at merchant locations. One exemplary method includes capturing a merchant indicator for a merchant in connection with a payment account transaction at the merchant for at least one product and receiving a checkout token for the payment account transaction from a person-to-merchant (P2M) engine. The checkout token is based, at least in part, on the captured merchant indicator. The method further includes transmitting a request for the payment account transaction at the merchant, where the request includes the checkout token, and whereby the consumer is permitted to purchase one or more products from the merchant, using the consumer's communication device and without interacting with a point-of-sale (POS) terminal.

### CROSS-REFERENCE TO RELATED APPLICATION

This application claims the benefit of, and priority to, U.S. Provisional Application No. 62/306,020 filed on Mar. 9, 2016. The entire disclosure of the above application is incorporated herein by reference.

### FIELD

The present disclosure generally relates to systems and methods for use in facilitating payment account transactions, and in particular, for use in facilitating transactions through consumer communication devices at merchant locations.

### BACKGROUND

This section provides background information related to the present disclosure which is not necessarily prior art.

Payment accounts are used by consumers to perform numerous different transactions including, for example, purchasing products (e.g., goods and/or services) from merchants, etc. It is known for the payment accounts to be associated with payment devices. As such, to initiate the transactions, the consumers typically present the payment devices to point of sale (POS) terminals at the merchants, which capture or otherwise obtain information for the associated payment accounts and submit authorization requests for the transactions to issuers associated with the payment accounts. If the authorization requests are approved, for example, by the issuers of the payment accounts, the merchants are notified so that the transactions may be concluded. Funds are later transferred between the issuers/consumers and the merchants, and others, for the concluded transactions.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating payment account transactions through consumer communication devices, at desired merchant locations;

FIG. 2 is a block diagram of a computing device that may be used in the exemplary system of FIG. 1;

FIG. 3 is an exemplary method, which may be implemented in connection with the system of FIG. 1, for registering a merchant so that payment account transactions at the merchant may be initiated through consumer communication devices;

FIG. 4 is an exemplary method, which may be implemented in connection with the system of FIG. 1, for facilitating a payment account transaction at a merchant through a consumer communication device; and

FIGS. 5-6 illustrate snippets of exemplary code segments, which may be implemented in the system of FIG. 1 and/or the method of FIG. 3 and/or the method of FIG. 4.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers are often in possession of communication devices, such as, for example, smartphones and tablets, etc., when shopping at merchants, or otherwise. Occasionally, the communication devices include payment applications, whereby the communication devices act as payment devices for payment accounts included in the payment applications and associated with the consumers. Generally, the payment applications interact with point of sale (POS) terminals at the merchants to initiate payment account transactions. Uniquely, the systems and methods herein permit the payment applications to initiate the payment account transactions (e.g., at checkout, etc.) upon capturing an indicator (e.g., an indicia, etc.) of the merchant (e.g., via a quick response (QR) code, via a signal associated with an iBeacon, via a signal associated with near-field communication (NFC), via a signal associated with radio-frequency identification (RFID), etc.), in lieu of conventional interaction with the POS terminals. As such, the consumers may be able to more efficiently and securely initiate the payment account transactions, without waiting in lines to checkout and without providing payment account information directly to the merchants, thereby potentially avoiding fraud circumstances associated with payment account information in the possession of the merchant. Further, the merchants may be able to reduce dependence on POS terminals and/or conventional checkout interactions to support payment account transactions. Moreover, the same operations can be used to affect both push-type transactions via issuers of the payment accounts and pull-type transactions via acquirers associated with the merchants.

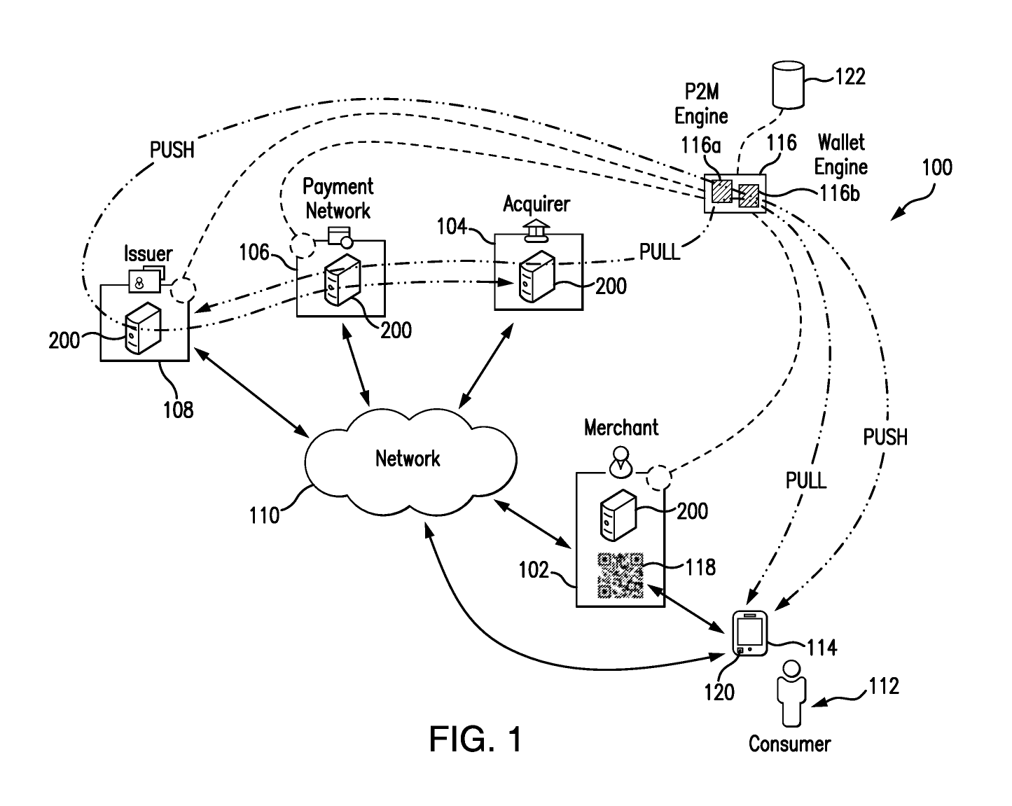

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, implementation of fund transfers/payments in the system 100, involvement of different parts of the system 100 in connection with transactions initiated at consumer communication devices, etc.

The system 100 generally includes a merchant 102, an acquirer 104, a payment network 106, and an issuer 108, each coupled to and in communication with network 110. The network 110 may include, without limitation, a local area network (LAN), a wide area network (WAN) (e.g., the Internet, etc.), a mobile network, a virtual private network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may be accessible to a consumer 112 (and specifically, a communication device 114 associated therewith) as well as other parts of the system 100, etc., as desired.

The merchant 102 in the system 100 is generally associated with products (e.g., goods and/or services, etc.) for purchase by one or more consumers (including consumer 112, for example). The merchant 102 offers the products for sale through one or more physical locations (e.g., brick-and-mortar stores, etc.) and/or through one or more virtual locations (e.g., network-based platforms (e.g., network-based application, websites, etc.), etc.), each generally permitting interactions by consumers to purchase (and pay for) the products (in conventional manners and as described herein).

The consumer 112 in the system 100 is in possession of a communication device 114 that is also coupled to (and in communication with) the network 110. The communication device 114 can generally be understood to be a portable communication device in the system 100 such as, for example, a mobile phone (e.g., a smartphone, etc.), a personal digital assistant (PDA), a tablet, a laptop, or other computing device suitable to be portable and/or carried by the consumer 112, etc., (although this is not required in all embodiments).

The consumer 112 is also associated with a payment account, provided by the issuer 108, that can be used to facilitate transactions at the merchant 102 to purchase products. In connection therewith, the communication device 114 includes a payment application 120, such as, for example, an electronic wallet (or e-wallet) application (e.g., a virtual wallet application, such as MasterPass®, Apple Pay®, Samsung Pay®, PayPal®, Google Wallet®, etc.), which configures the communication device 114 to operate as a payment device, associated with the consumer's payment account, and further to operate as described herein.

While one merchant 102, one acquirer 104, one payment network 106, one issuer 108, one consumer 112, and one communication device 114 are illustrated in FIG. 1, it should be appreciated that any number of these entities/devices (and their associated components) may be included in the system 100, or may be included as a part of systems in other embodiments, consistent with the present disclosure.

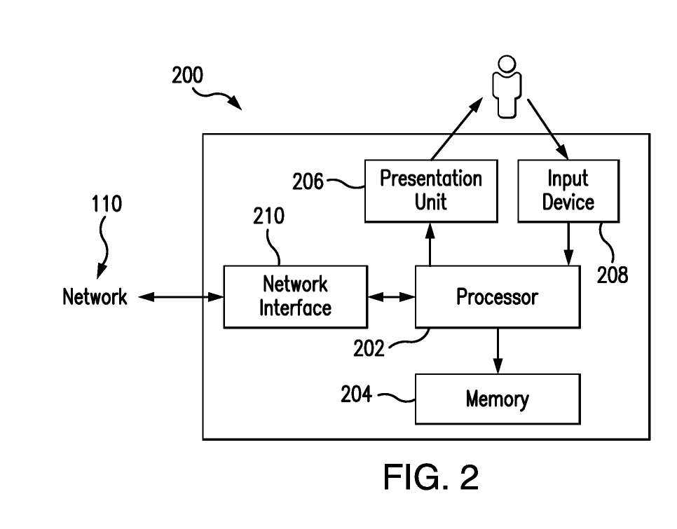

FIG. 2 illustrates an exemplary computing device 200 that can be used in the system 100. The computing device 200 may include, for example, one or more servers, workstations, personal computers, laptops, tablets, smartphones, PDAs, point-of-sale (POS) devices, etc. In addition, the computing device 200 may include a single computing device, or it may include multiple computing devices located in close proximity or distributed over a geographic region, so long as the computing devices are configured to function as described herein. In the system 100, each of the merchant 102, the acquirer 104, the payment network 106, and the issuer 108 are illustrated as including, or being implemented in, computing device 200, coupled to (and in communication with) the network 110. In addition, the communication device 114 associated with the consumer 112 should be considered a computing device consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, account information, merchant data, token data, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information visually, for example, to a user of the computing device 200, such as the consumer 112; users associated with one or more of the acquirer 104, the payment network 106, and/or the issuer 108; etc. Various interfaces (e.g., as defined by network-based applications, websites, etc., such as e-wallet or virtual wallet interfaces; etc.) may be displayed at computing device 200, and in particular at presentation unit 206, to display certain information, as described herein. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, captured merchant indicators, etc. The input device 208 is coupled to (and is in communication with) the processor 202 and may include, for example, one or more of a keyboard, a pointing device, a mouse, a stylus, a card reader, another data or symbol reader (for reading data or other symbols as referenced herein, for example, QR codes, etc.), a camera, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device. Similarly, the input device 208 may be included and/or incorporated, in whole, or in part, with one or more network interfaces 210, as described below, whereby it is capable of reading RFID, NFC, iBeacon or other wired or wireless signals, etc.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. In one or more embodiments, the network interface 210 includes a wireless radio-frequency (RF) device, such as, for example, a Bluetooth device, an RFID device, an NFC device, or another device suitable to detect (broadly, capture) one or more signals (broadly, indicators) emitted at and/or associated with one or more merchants, such as, for example, merchant 102. In some exemplary embodiments, the computing device 200 includes the processor 202 and one or more network interfaces incorporated into or with the processor 202.

Referring again to FIG. 1, the system 100 includes a purchase engine 116, which is configured, by executable instructions, to operate as described herein. The engine 116 is illustrated as a standalone part of the system 100 and, in this manner, may be considered one or more computing devices consistent with computing device 200. Additionally, or alternatively, the engine 116, as indicated by the dotted lines, may be integrated, in whole or in part, with the merchant 102, the payment network 106, and/or the issuer 108 (e.g., as part of the computing device 200 associated therewith, etc.). In addition, the engine 116 includes a person to merchant (P2M) engine 116a (or portion) and a wallet engine 116b (or portion), which together may be considered one or more computing devices consistent with computing device 200 or which individually may each be considered one or more computing devices consistent with computing device 200. While the P2M engine 116a and the wallet engine 116b are both illustrated as components of the engine 116 (such that the engine 116, in general, can be viewed as performing the functions of the P2M engine 116a and the wallet engine 116b), it should be appreciated that in other embodiments the P2M engine 116a and the wallet engine 116b may be separate parts of the system 100.

In addition, the engine 116 is coupled to a data structure 122, which may be standalone from the engine 116 or, as indicated by the dotted line, may be incorporated in whole, or in part, with the engine 116. The data structure 122 includes, for example, merchant information regarding the merchant 102, a checkout identifier (ID) for the merchant 102, etc.

Initially in the system 100, the engine 116 (particularly the P2M engine 116a) is configured to register the merchant 102 for a service (via a network-based platform) whereby the consumer 112 is enabled to initiate a payment account transaction at the merchant 102 using the communication device 114, in lieu of using a POS terminal (e.g., a “POS terminal-free” service or transaction, etc.). While referred to herein as “POS terminal-free,” or in lieu of using a POS terminal, it should be appreciated that the description herein does not restrict any and all use of a POS terminal. Rather the terms only indicate that the operations described herein are generally accomplished apart from the POS terminal, and thus diverge from conventional use of the POS terminal. The methods and systems herein may still rely on the POS terminal for certain operations (e.g., providing a shopping cart of products (and product information) to be purchased by the consumer 112, etc.).

As part of the registration for the merchant 102, the P2M engine 116a is configured to provide a unique computer-readable merchant indicator 118 (illustrated as a QR code in FIG. 1, but which may also (or alternatively) be embodied as and/or included in a signal associated with iBeacons, NFC tags, RFID tags, etc.) to the merchant 102, that can be identified (or otherwise read or captured), for example, by the consumer's communication device 114 in connection with initiating a POS terminal-free transaction at the merchant 102. The computer-readable merchant indicator 118 is based on (and generally includes and/or is associated with) various information about the merchant 102 (broadly, merchant information) captured/solicited during the registration. Such merchant information may include, for example, a checkout ID for the merchant 102 (as described more in connection with the method 300), information related to the merchant's account (which may include a bank account, payment account, demand deposit account, and/or deposit account, etc.), information related to the merchant's acquirer 104 (e.g., acquirer name, acquirer address, acquirer ID, etc.), contact information for the merchant 102 (e.g., merchant name, merchant address, merchant phone number, etc.), a merchant ID for the merchant 102, a merchant account number for the merchant 102, and a preferred currency type for use at the merchant 102 (e.g., US dollars, etc.), etc. The merchant indicator 118 may also be product-specific, such that it includes and/or is associated with product information for one or more particular products associated therewith or with the merchant 102 in general (e.g., product name, product brand, product price, etc.).

In this manner, the merchant indicator 118 may vary by product and/or group of products, whereby the merchant 102 may be associated with multiple merchant indicators. In at least one embodiment, where the merchant indicator 118 is generic to multiple products, a product or product data may be identified based on the merchant indicator 118 and certain merchant data (from the merchant 102 and/or included in the payment application 120). The P2M engine 116a is then configured to store the collected merchant information in the data structure 122.

As such, in the system 100, the merchant indicator 118 is generally indicative of the merchant 102 and, in some embodiments, the merchant's products, such that the communication device 114, upon capturing the merchant indicator 118, is able to generally identify the merchant 102 and understand the available merchant information for the merchant 102 (as associated with the indicator 118). However, in other embodiments, the merchant indicator 118 may be devoid of particular information regarding the merchant 102, whereby the communication device 114, upon capturing the merchant indicator 118, is not able to understand anything more than a number (checkout ID, for example) to be included in a transaction request (where the number may then be separately associated with the merchant 102, at the engine 116 (e.g., in memory 204, etc.) and the merchant information collected at registration). Registration of the merchant 102 by the P2M engine 116a will be described in more detail, for example, in connection with method 300.

In some embodiments, account information for the merchant 102, which is encoded in (or otherwise associated with) the merchant indicator 118, may include a deposit only account number, whereby possession and/or use of the account number permits a user to only deposit funds to the account and not withdraw funds from the account. In addition, in some embodiments, the merchant indicator 118 may be dynamic in nature, such that the merchant 102 may include product pricing information, or other dynamic information, in the merchant indicator 118 (e.g., via the P2M engine 116a, etc.).

It should be appreciated that the merchant indicator 118 may include any suitable visible (or invisible) symbols or form or computer-readable indicia (e.g., barcodes, other visible patterns/symbols, etc.) or any suitable computer-readable signals (or indicia), which can be captured by a computing device (e.g., a camera input device 208, a network interface 210, etc.), etc. For example, in the illustrated system 100, the merchant indicator 118 is encoded into the QR code. In other embodiments, however, the merchant indicator 118 may be associated with an RFID tag/device/element, a beacon (e.g., an iBeacon, etc.), an NFC tag/device/element, a Bluetooth tag/device/element, etc., which emits a signal representative of the merchant indicator 118.

With continued reference to FIG. 1, in connection with a payment account transaction by the consumer 112 at the merchant 102 to purchase desired products, the communication device 114 is configured to capture (e.g., read, detect, etc.) the merchant indicator 118 (e.g., via input device 208, network interface 210, etc.), at the merchant location, whether physical or virtual, etc. For example, the merchant indicator 118 may be disposed at a “checkout” location within the physical store of the merchant 102 or on advertising associated with the merchant 102, or it may be displayed to the consumer 112 as part of an interface of the merchant's website at a virtual location of the merchant 102, etc. In this way, the merchant indicator 118 permits the consumer 112 to identify the merchant 102.

In addition, the communication device 114, via the payment application 120, is configured to capture information relating to the product(s) to be purchased by the consumer 112 in the payment account transaction (e.g., product descriptions, product prices, a total purchase amount, purchase discounts, a merchant category code for the transaction, etc.). To do so, the communication device 114 may be configured to prompt the consumer 112 to enter the product information to the payment application 120. Or, the payment application 120, at the communication device 114, may be configured to request the product information from a shopping cart application also at the communication device 114.

Then, based on the information included in the merchant indicator 118 (e.g., the checkout ID for the merchant 102, etc.) and the product information obtained by the payment application 120 (e.g., the product name, the product amount, etc.), the consumer's communication device 114 (and specifically, the payment application 120) is configured to then generate a transaction request for the underlying purchase of the product(s) and to transmit the transaction request to the P2M engine 116a. As part of generating the transaction request, the consumer 112 may be prompted, by the communication device 114 (and the payment application 120 thereon), to verify the merchant 102, the amount of the purchase, and/or other details of the transaction (e.g., product name, product brand, etc.). The request includes the captured information for the merchant 102 and for the product to be purchased, and an instruction to generate a token (or checkout token, or P2M token, etc.) for the transaction. In response, the engine 116 is configured to generate the token, which is specific to the merchant 102 and/or the transaction for the product(s). The transaction request, and generation of the token by the P2M engine 116a, will be described in more detail hereinafter, for example, in connection with method 400. The engine 116 is further configured to provide the token back to the payment application 120, and the consumer 112 (at the communication device 114). Thereafter, the consumer 112 may select, via the payment application 120, the payment account for use in the transaction (e.g., from different available payment accounts, bank accounts, etc., at the consumer's payment application 120) as a source to fund the transaction (e.g., prior to or upon receipt of the token from the P2M engine 116a, etc.), and, potentially, to select a push or pull transaction type (although in various embodiments the transaction type may be predefined by the merchant 102, for example, at registration with the P2M engine 116a, and/or the acquirer 104). Once the payment account is selected, in this exemplary embodiment, the payment application 120 is configured to submit the token and the selected payment account (e.g., payment account credentials for the payment account, etc.) to the engine 116 (e.g., the wallet engine 116b, etc.) to facilitate the transaction.

In turn, the engine 116 (particularly the wallet engine 116b) is configured to receive the token from the consumer's communication device 114 (as populated with information regarding the merchant and the product to be purchased) and to contact the P2M engine 116a with the request. In turn, the P2M engine 116a is configured to generate an authorization request (e.g., a message consistent with the ISO 8583 standard, etc.), as appropriate, to cause the transaction to proceed in accordance with the desired push/pull type (as indicated by the consumer 112 or by the merchant 102). While the authorization request is generated by the P2M engine 116a in this embodiment, it should be appreciated that the generation of the authorization request may be segregated to a separate engine and/or service in other embodiments. Regardless, the authorization request is based on the information included in the token received from the consumer's communication device 114, and any additional information retrieved by the wallet engine 116b and from the data structure 122 associated with the wallet engine 116b.

With that said, in one example, the P2M engine 116a is configured to generate the authorization request as a pull-type transaction and direct the authorization request to the acquirer 104, as indicated by the dotted line in FIG. 1 referenced PULL. The acquirer 104, in turn, is configured to communicate the authorization request to the issuer 108, through the payment network 106, such as, for example, through MasterCard®, VISA®, Discover®, American Express®, etc., to determine (in conjunction with the issuer 108) whether the consumer's payment account is in good standing and whether there is sufficient credit or funds to complete the transaction. If the issuer 108 accepts the transaction, a reply authorizing the transaction is conventionally provided back to the acquirer 104 (through the payment network 106) and to the P2M engine 116a. The P2M engine 116a then notifies the consumer 112, via the communication device 114, that the transaction is accepted, permitting the consumer 112 to complete the transaction and offer proof of purchase to the merchant 102 to retrieve the product(s). The transaction is later cleared and/or settled by and between the acquirer 104, the payment network 106, and the issuer 108 (based on agreements therebetween and through further communication therebetween). However, if the issuer 108 declines the transaction, a reply declining the transaction is provided back to the P2M engine 116a, which then informs the consumer 112 of the declined transaction, via the communication device 114.

Conversely, in another example, the P2M engine 116a is configured to generate the authorization request as a push-type transaction and direct the authorization request to the issuer 108, as indicated by the dotted line in FIG. 1 referenced PUSH (or alternatively, to the issuer 108 through the payment network 106). The issuer 108 determines whether the payment account is in good standing and whether there is sufficient credit or funds to complete the transaction. Like above, if the issuer 108 accepts the transaction, a reply authorizing the transaction is provided to the P2M engine 116a (either directly, or through the payment network 106). The P2M engine 116a then notifies the consumer 112, via the communication device 114, that the transaction is accepted, permitting the consumer 112 to complete the transaction and offer proof of purchase to the merchant 102 to retrieve the product(s). The issuer 108 further informs the acquirer 104 of the accepted transaction and/or appends a record to one or more clearing data structures indicating the transfer to the merchant's account at the acquirer 104, and prior to clearing and settlement among the entities, as indicated above. If the issuer 108 declines the transaction, a reply declining the transaction is provided to the P2M engine 116a, which then informs the consumer 112 of the declined transaction, via the communication device 114.

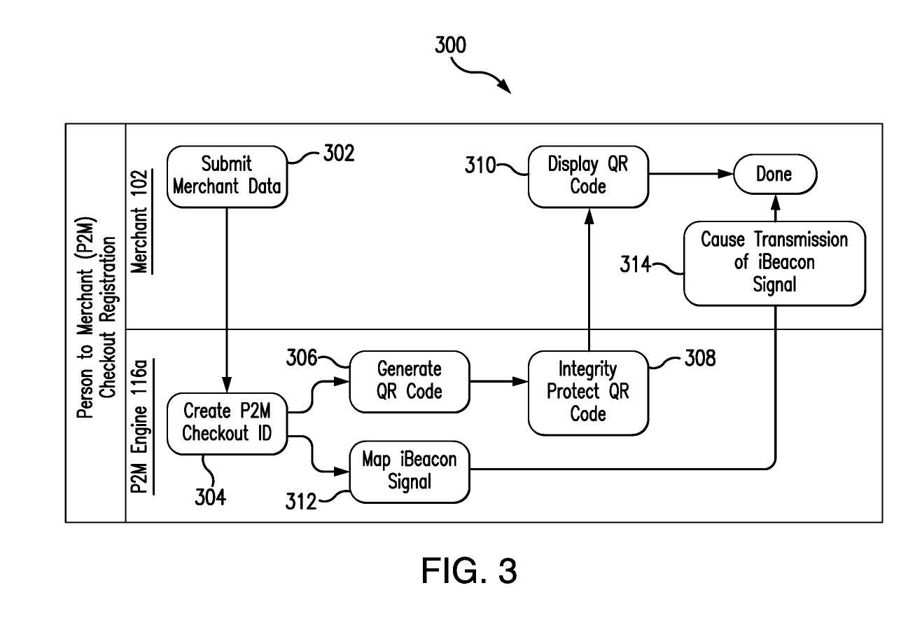

FIG. 3 illustrates an exemplary method 300 for registering the merchant 102, by the engine 116 (particularly, the P2M engine 116a) in connection with allowing the merchant 102 to facilitate payment account transactions through the communication device 114 associated with the consumer 112 and, for example, potentially independent of a POS terminal at the merchant 102. As such, the exemplary method 300 is described as implemented in the P2M engine 116a of the system 100. However, it should be understood that the method 300 is not limited to this particular configuration, as the method 300 may be implemented, at least in part, in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 300.

When the merchant 102 desires to utilize the service described herein, to facilitate payment account transactions generally independent of POS terminals, for example, the merchant 102 initially provides various merchant information to the P2M engine 116a, at 302, in connection with registering for such service (e.g., registering to a network-based platform supporting the service, etc.). Such merchant information may include, for example, a name of the merchant 102, an address of the merchant 102, a phone number of the merchant 102, a merchant identification (ID) for the merchant 102, a merchant account number for the merchant 102, product information, and a desired currency of the merchant 102 (e.g., US dollars, etc.), etc. The P2M engine 116a may then store the information for the merchant 102 in the data structure 122. In addition, the merchant 102 may specify how transactions are to be processed, for example, as pull transactions via the acquirer 104 or as push transactions via the issuer 108 (as described above in connection with the system 100). It should be appreciated that the specified transaction type (pull or push) may alter the information collected by the P2M engine 116a during registration (e.g., when pull-type transactions are specified, the P2M engine 116a may collect a merchant ID, merchant name, merchant phone number, merchant address, merchant account number, desired currency, and merchant category code, but when push-type transactions are specified, the P2M engine 116a may only collect a merchant ID, merchant name, merchant phone number, merchant address, and desired currency; etc.), however it does not affect the ability to utilize the consumer's communication device 114 to initiate a transaction in lieu of a POS terminal.

In turn in the method 300, the P2M engine 116a receives the information provided by the merchant 102 and creates the checkout ID (e.g., a P2M checkout ID, etc.) for the merchant 102, at 304. The P2M engine 116a may then store the checkout ID for the merchant 102 in the data structure 122. The checkout ID generally includes, or represents, or is associated with the various information provided to the P2M engine 116a by the merchant 102 during the registration.

The P2M engine 116a then generates the merchant indicator 118 for the merchant 102 based on the checkout ID. This may include encoding, by the P2M engine 116a, the checkout ID into or as part of the merchant indicator 118. Or, it may include encoding one or more aspects of the merchant information from the checkout ID into or on the merchant indicator 118, or it may include simply encoding a number associated with the merchant 102 (as determined from the checkout ID, for example) into or on the merchant indicator 118. In the method 300, the merchant indicator 118 comprises all the various merchant information included in the checkout ID, but may include less in other embodiments (e.g., the checkout ID. etc.). As will be described more with reference to method 400, the data associated with the merchant indicator 118, by the P2M engine 116a, can then be used to route a transaction at the merchant 102 to the acquirer 104 (in a pull-type transaction) or to the issuer 108 (in a push-type transaction)

With that said, the particular merchant indicator 118 generated by the P2M engine 116a (e.g., represented by and/or encoded in the QR code illustrated in FIG. 1, and/or a signal emitted from an iBeacon, RFID tag, or NFC tag, etc.) in the method 300 may include a particular indicator as requested by the merchant 102 during registration, or it may include an indicator specified by the P2M engine 116a. For example, in the illustrated method 300 the merchant 102 may request (or the P2M engine 116a may specify) that the indicator 118 include a QR code for virtual merchant locations, and an iBeacon signal for brick-and-mortar merchant locations. In this example, when the merchant indicator 118 includes the QR code, the P2M engine 116a generates the QR code, at 306, to include the merchant data. The P2M engine 116a then integrity protects the QR code, at 308, and transmits it to the merchant 102. In turn, the merchant causes the QR code to be displayed, at 310, as desired (e.g., at a “checkout” location within a physical store of the merchant 102, as part of an interface of the merchant's website, etc.). And when the merchant indicator 118 includes the iBeacon signal, the P2M engine 116a maps the merchant data to the iBeacon signal, at 312, such that the signal produced by the iBeacon includes the appropriate information. The merchant 102 then causes transmission of the iBeacon signal, at 314. While the method 300 is described in connection with the QR code and the iBeacon signal, it should be appreciated (as indicated above) that the merchant indicator 118 may include other suitable indicia, signals, etc., within the scope of the present disclosure (and generated, mapped, etc., to include the merchant information, generally in the manner described above).

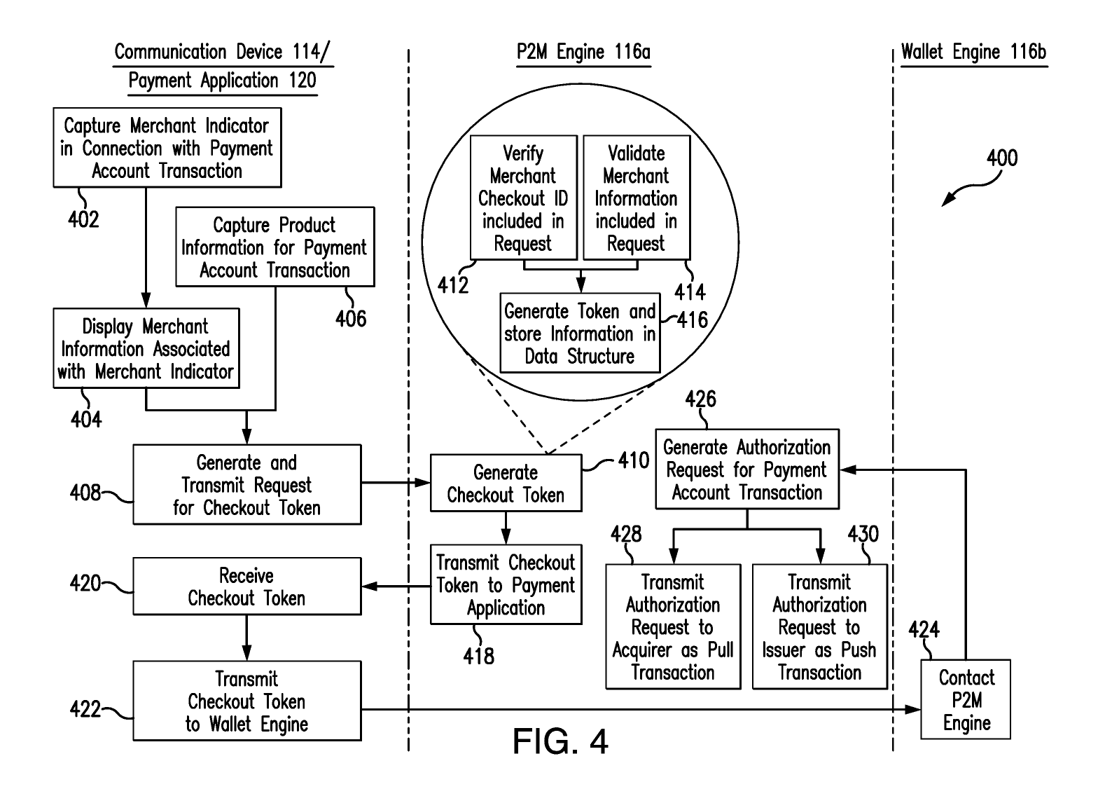

FIG. 4 illustrates an exemplary method 400 for facilitating a payment account transaction, via the consumer's communication device 114, at the merchant 102 using the merchant indicator 118 instead of a POS terminal. The exemplary method 400 is described as implemented in the consumer's communication device 114 of the system 100, via the payment application 120 associated therewith, and in the engine 116. However, it should be understood that the method 400 is not limited to this configuration, as the method 400 may be implemented, at least in part, in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 400.

Generally in the method 400, the communication device 114 associated with the consumer 112 includes the payment application 120 installed thereon. In addition, the merchant 102 is registered, via the P2M engine 116a (as generally described above in connection with the method 300), to a network-based platform associated with the engine 116 so that the various operations described herein can be utilized to facilitate a payment account transaction by the consumer 112 for the products at the merchant 102.

In some implementations of the method 400, the communication device 114 may include a shopping cart application, which may be part of the payment application 120 or separate therefrom (and communicating with the payment application 120). In addition, the shopping cart application may be specific to the merchant 102, or may be generic for collecting desired items to purchase. Regardless, the shopping cart application permits the consumer 112 to capture indicia associated with products to add them to a “shopping cart.” When the consumer 112 has selected and/or captured all the products for purchase in a particular transaction, the shopping cart application provides product information, total charges, and delivery information for the transaction to the consumer 112, and the consumer 112 proceeds as provided below (e.g., as part of “checking out,” etc.). In other implementations of the method 400, product information, product prices, total charges, and/or other relevant information for a transaction at the merchant 102, if any, may be provided to the communication device 114 (and, particularly, to the payment application 120) in one or more other manners, for example, manually by the consumer 112 via inputs to the communication device 114, via dynamic product information included in the merchant indicator 118, etc.

As shown in FIG. 4, when the consumer 112 desires to initiate a payment account transaction for a product at the merchant 102 (e.g., at a physical location associated with the merchant 102) (e.g., for a product or products included in the corresponding shopping cart (as described above) or otherwise, etc.), the consumer initially captures the merchant indicator 118 associated with the merchant 102, at 402, using the communication device 114, as allowed and/or configured by the payment application 120 thereon. This may include, for example, scanning a QR code at the merchant 102, reading a signal from an iBeacon, reading a signal from an RFID tag, reading a signal from an NFC tag, etc. In this way, the merchant indicator 118 permits the consumer 112 to identify the merchant 102. The payment application 120 then causes, at 404, the various information relating to the merchant 102, and associated with the merchant indicator 118 (e.g., merchant name, merchant address, merchant phone number, etc.), to display to the consumer 112 at the communication device 114 (e.g., at presentation unit 206, etc.), so that the consumer 112 can verify that the merchant information from the indicator 118 in fact relates to the merchant 102 at which the consumer is initiating the transaction.

As an example, when the merchant indicator 118 includes the QR code (as illustrated in FIG. 1), capturing the indicator 118 may include scanning an image of the QR code using a camera (broadly, an input device 208) associated with the communication device 114. From the QR code (e.g., from a data element associated with the QR code, etc.), the payment application 120 can determine, for example, the checkout ID for the merchant 102, which may include the merchant ID for the merchant 102 (used to identify the merchant 102), merchant account number for the merchant 102, contact information for the merchant 102 (e.g., the merchant name, merchant address, merchant phone number, etc.), and/or the desired currency used by the merchant 102. It should be appreciated that the QR code may be, in at least one embodiment, encoded with data as a delimited string due to density concerns relating to quality of various cameras and QR reading software.

As another example, capturing the indicator 118 may include capturing (or reading) the signal from an iBeacon using the input device 208 and/or the network interface 210 of the communication device 114. The iBeacon signal is representative of the merchant indicator 118 that is able to be mapped to the checkout ID for the merchant 102. When the iBeacon signal is received, a mapping is then made to determine the checkout ID (as described above in the system 100). The iBeacon signal (or the information associated with the iBeacon identifier) may further include, in a similar manner to the QR code in the above example, the merchant ID for the merchant 102, the merchant account number for the merchant 102, contact information for the merchant 102 (e.g., the merchant name, merchant address, merchant phone number, etc.), and/or the desired currency used by the merchant 102. It should be appreciated that the merchant indicator 118 associated with the iBeacon signal is typically a UUID/GUID, which is “burned in” to the corresponding device and unchangeable by end-users.

Again, it should be appreciated that the merchant indicator 118 is not limited to a QR code or an iBeacon signal as described above, and may include other indicia, signals, etc., in other examples and/or embodiments.

With continued reference to FIG. 4, after (or before) capturing the merchant indicator 118, the communication device 114, via the payment application 120, captures information relating to the product(s) to be purchased by the consumer 112, at 406 (e.g., product price, product description, transaction amount, etc.). As described above, this may include prompting the consumer 112 to enter the product information to the payment application 120 (e.g., via input device 208, etc.). Or, this may include the payment application 120 requesting the product information from a shopping cart application at the communication device 114. Further yet, in some embodiments, this may include obtaining the product information based on a dynamic aspect of the merchant indicator 118 (where the product information is included in, or can be gleaned from, the captured merchant indicator 118). In one example, each product or group of products is associated with a unique merchant indicator 118, such that the product information (or part thereof) is available therefrom. In any case, the product information may include a product description, a product price, a total purchase amount, any purchase discounts, a merchant category code for the transaction, etc.

Next in the method 400, the communication device 114, via the payment application 120, requests a checkout token (or P2M token, etc.) for the transaction, at 408 (broadly, generates a transaction request) (e.g., enabled through a payment application software development kit (SDK) at the communication device 114, etc.). In particular, the communication device 114, via the payment application 120, generates and transmits a request to the engine 116 (e.g., to the P2M engine 116a, etc.), including the checkout ID for the merchant 102 (as obtained from the merchant indicator 118) and also including information for the product(s) to be purchased by the consumer 112. When the merchant indicator 118 is associated with a QR code (or signal emanating from an iBeacon, RFID tag, or NFC tag, etc.), for example, the request may include the data (e.g., information relating to the merchant 102, information relating to the transaction, etc.) in a serialized fixed length string, as read from the QR code (or signal associated with the iBeacon, RFID tag, or NFC tag, as appropriate).

Then, based on the information in the request (regardless of the form of the merchant indicator 118), the P2M engine 116a generates the token, at 410. The token may include, for example, the data included in the transaction request and/or an opaque correlation identifier that uniquely identifies the merchant 102 and/or corresponding product purchase information (e.g., product name, product brand, product price, transaction amount, etc.), by reference and/or correlation to data stored in the data structure 122, for example. More particularly, as part of generating the token at 410, the P2M engine 116a retrieves the checkout ID (or QR code or signal data for iBeacon, for example) from the request and identifies it in the data structure 122, at 412, for example, to verify it and ensure that it is valid (e.g., that the merchant 102 identified in the request is actually registered with the engine 116, etc.). In so doing, the P2M engine 116a also validates the information included in the request (e.g., the information included along with the checkout ID, etc.), at 414, against corresponding lookup data in the data structure 122. As an example, when the merchant indicator 118 includes the QR code, the P2M engine 116a may hash the QR data and the corresponding lookup data, and then compare the hashes to ensure integrity. Regardless, when the information included in the request is validated, the P2M engine 116a then generates the checkout token, which may include and/or be associated with the various information included in the request (e.g., by the opaque correlation identifier, etc.), at 416 (e.g., the information associated with the checkout ID, the product purchase information, etc.), and (when not included in the token) store the information in the data structure 122.

As such, the checkout token may include the checkout ID, as well as a payment type indication (e.g., a pull-type transaction to the acquirer 104, a push-type transaction to the issuer 108, etc.) if not already included in the checkout ID, and the product purchase information for the underlying transaction. Additionally, or alternatively, the checkout token may include an identifier, number, code, etc. (e.g., the opaque correlation identifier, etc.), which is associated with data in the data structure 122 indicative of, for example, the checkout ID, the payment-type, and/or the product purchase information, etc., which may be stored in the data structure 122 (and potentially excluded from the token), in response to the transaction request. In general, by the generating the checkout token, the consumer 112 is bound or tied to the transaction, whereby the transaction details as listed above, and others, may be recalled from the token and/or the data structure 122 (based on the token) in connection with a transaction, as described below. By associating and/or including the checkout ID and/or the product purchase information with the token, subsequent transactions based on the token (as described below) may provide transaction data including details relating to the transaction (as included in the product purchase information) and/or may permit feedback to the payment application 120, whereby the consumer 112 is able to confirm and/or verify one or more aspects of the transaction.

It should be appreciated that in one or more embodiments the information relating to the consumer 112, the merchant 102, the payment type, and/or the product purchase information may be split between the token and the data structure 122 such that some is included in the token while the remainder is included in the data structure 122, consistent with above.

The P2M engine 116a then transmits the token back to the communication device 114, at 418, and the communication device 114, via the payment application 120, receives the token, at 420. As needed, the communication device 114, via the payment application 120, associates with the token additional information regarding the merchant 102 and the underlying transaction (if not already done by the P2M engine 116a) and, for information already present in the token and/or associated with the token, performs a verification. For example, the communication device 114, via the payment application 120, may cause the information from the token to display to the consumer 112 so that the consumer can review the information and confirm or decline the token, as appropriate (e.g., via an express input to the communication device 114, etc.). In addition, if not done already, the consumer 112 may specify a particular payment account (e.g., a particular payment card, etc.) from the payment application 120 for use in the transaction (in which case the payment application 120 may append the selected payment account to the token).

Upon receiving the token from the P2M engine 116a (and when verified, as appropriate), the communication device 114, via the payment application 120, next transmits the token (with appropriate payment account information) to the engine 116 (specifically, to the wallet engine 116b), at 422, and also, potentially, one or more payment account credentials associated with the consumer 112 and/or the consumer's payment account (e.g., a primary account number (PAN), payment token, etc.). In turn, the wallet engine 116b contacts the P2M engine 116a, at 424. This may include retrieving and providing one or more payment account credentials associated with the consumer 1122 and/or the consumer's payment account, or this may include simply forwarding the one or more payment account received from the payment application 120. In either event, the wallet engine 116b provides the checkout token and the one or more payment account credentials to the P2M engine 116a. It should be appreciated that while the token is directed to the P2M engine 116a, via the wallet engine 116b, in one or more embodiments the payment application 120 may provide the token and associated information, as desired or required, directly to the P2M engine 116a or, potentially, to another intermediate therebetween. In other words, the wallet engine 116b may be omitted in one or more such embodiments.

Then, the P2M engine 116a generates an authorization request, based on the checkout token and/or associated information (included in the token and/or in the data structure 122, retrieved based on the token), as appropriate, at 426, and transmits the authorization request to either the acquirer 104, at 428, as part of a pull transaction (e.g., a send money transaction, etc.) or the issuer 108, at 430, as part of a push transaction (e.g., a create payment transaction, etc.), as described above in connection with the system 100. The P2M engine 116a, in at least one embodiment, is instructed to transmit the authorization request to the acquirer 104 or the issuer 108, as identified in the checkout token (received from the wallet engine 116b and/or the payment application 120).

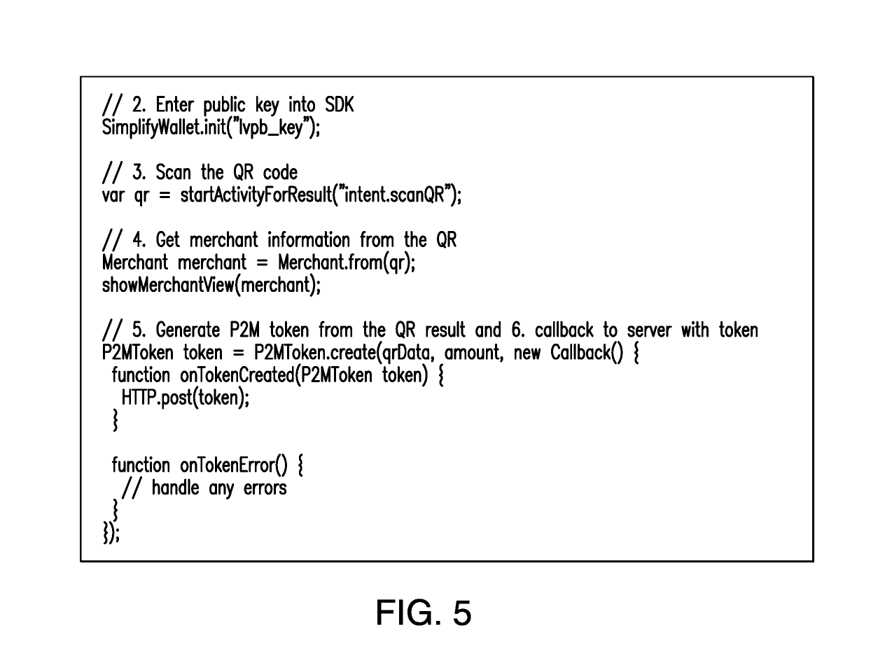

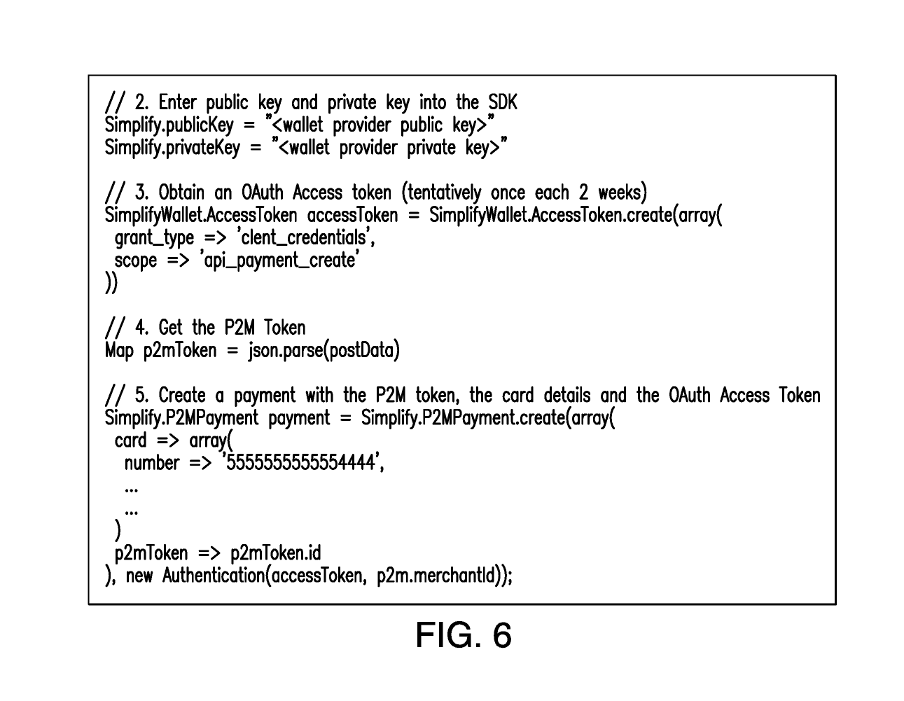

FIGS. 5 and 6 include exemplary codes segments, or snippets, which form part of the payment application 120 at the consumer's communication device 114 and the engine 116. In particular, FIG. 5 illustrates an exemplary code segment associated with integration of a payment application SDK at the communication device 114. This code segment describes, for example, operations relating to supplying a public key to the SDK, implementing QR scanning, implementing merchant information display, and generating a checkout token. And, FIG. 6 illustrates an exemplary code segment associated with integration of an SDK for the engine 116. This code segment describes, for example, operations relating to supplying a public and private key to the SDK, retrieving an OAuth Access Token (e.g., client credentials granting scope to creating payments only), implementing an endpoint to accept a checkout token, and creating a payment supplying the checkout token, the OAuth Access Token, and payment device credentials.

In view of the above, the systems and methods herein provide for person to merchant (P2M) payments via a P2M engine and a merchant indicator associated with the corresponding merchant. In particular, in connection with a product purchase from the merchant by a consumer, the P2M engine generates a checkout token associated with the merchant indicator and the underlying transaction, which is then provided to the consumer. That token, in combination with payment account credentials for the consumer's payment account, is then provided to the P2M engine and/or an associated wallet engine, for example, to initiate the transaction. In this manner, in various embodiments, certain interactions with a conventional POS terminal at the merchant may be omitted, thereby improving, through a technological solution, the interaction between the consumer and the merchant in order for the consumer to purchase the products from the merchant. Beyond such efficiency, in certain embodiments the consumer is further able to limit and/or eliminate providing payment account credentials directly to the merchant for his/her payment account in connection with purchasing the products, and/or in a manner in which the merchant otherwise receives the payment account credentials. As such, in this way, the systems and methods herein may limit and/or reduce incidences of fraud associated with the merchant possessing the payment account credentials for the consumer.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of the following: (a) capturing a merchant indicator for a merchant in connection with a payment account transaction at the merchant for at least one product; (b) receiving a checkout token for the payment account transaction, from a person-to-merchant (P2M) engine, wherein the checkout token is based, at least in part, on the captured merchant indicator; (c) transmitting a request for the payment account transaction at the merchant, the request including the checkout token, whereby the consumer is permitted to purchase one or more products from the merchant, using the consumer's communication device and without interacting with a point-of-sale (POS) terminal; (d) capturing information for the at least one product, the information including at least a price of the at least one product; (e) generating a request for the checkout token, the request including information retrieved from the merchant indicator and the information for the at least one product; (f) transmitting the request to the P2M engine; (g) displaying a merchant name, in response to capturing the merchant indicator; (h) prompting the consumer to verify the merchant name, prior to transmitting the request for the payment account transaction; (i) prompting the consumer to select a payment account for the payment account transaction, prior to transmitting the request for the payment account transaction; (j) receiving a selection of a payment account; and (k) prompting the consumer to select between a push transaction type and a pull transaction type.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating payment account transactions to a merchant, the computer-implemented method comprising:
capturing, by a communication device associated with a consumer, a merchant indicator for a merchant in connection with a payment account transaction at the merchant for at least one product;
receiving a checkout token for the payment account transaction, from a person-to-merchant (P2M) engine, wherein the checkout token is based, at least in part, on the captured merchant indicator; and
transmitting, by the communication device, a request for the payment account transaction at the merchant, the request including the checkout token, whereby the consumer is permitted to purchase one or more products from the merchant, using the consumer's communication device and without interacting with a point-of-sale (POS) terminal.

2. The computer-implemented method of claim 1, further comprising capturing, by the communication device, information for the at least one product, the information including at least a price of the at least one product.

3. The computer-implemented method of claim 2, further comprising:
generating a request for the checkout token, the request including information retrieved from the merchant indicator and the information for the at least one product; and
transmitting the request to the P2M engine.

4. The computer-implemented method of claim 3, further comprising displaying, at the communication device, a merchant name, in response to capturing the merchant indicator; and
prompting the consumer, by the communication device, to verify the merchant name, prior to transmitting the request for the payment account transaction.

5. The computer-implemented method of claim 4, wherein transmitting the request for the payment account transaction includes transmitting, to a wallet engine and/or the P2M engine, the request including one or more of the merchant name, a merchant ID for the merchant, a merchant account number for the merchant, and a merchant address for the merchant.

6. The computer-implemented method of claim 1, further comprising:
prompting the consumer to select, at the communication device, a payment account for the payment account transaction, prior to transmitting the request for the payment account transaction; and
receiving a selection of a payment account; and
wherein the request for the payment account transaction includes payment account credentials for the selected payment account.

7. The computer-implemented method of claim 1, further comprising prompting the consumer to select between a push transaction type and a pull transaction type; and
wherein the payment account transaction request indicates the selected one of the push transaction and the pull transaction.

8. The computer-implemented method of claim 1, wherein the merchant indicator includes computer-readable indicia comprising at least one of a radio-frequency identification (RFID) signal, a barcode, a quick response (QR) code, and a near-field communication (NFC) signal.

9. A computer-implemented method for use in facilitating payment account transactions, the method comprising:
receiving, by a computing device, from a communication device associated with a consumer, a request for a checkout token for a transaction for purchase of one or more products, by the consumer, from a merchant, the request including a checkout ID associated with the merchant;
generating, by the computing device, the checkout token based on the checkout ID; and
transmitting the checkout token to the consumer, whereby the consumer is permitted to initiate the transaction for the purchase of one or more products from the merchant, through use of the checkout token, and without presenting a payment account credential to a point-of-sale (POS) terminal associated with the merchant.

10. The computer-implemented method of claim 9, further comprising:
soliciting, by the computing device, merchant information for the merchant, the merchant information including a selection between a push transaction type and a pull transaction type; and
defining a computer-readable merchant indicator associated with the merchant, based on the merchant information, whereby consumers are able to initiate payment account transactions, with the merchant, based on the computer-readable merchant indicator, via consumers' communication devices, apart from the POS terminal associated with the merchant.

11. The computer-implemented method of claim 10, further comprising causing the computer-readable merchant indicator, or a device for generating the computer-readable merchant indicator, to be delivered to the merchant.

12. The computer-implemented method of claim 9, further comprising:
receiving, from the consumer, the checkout token and a payment account credential for the transaction for purchase of the one or more products; and
generating, by the computing device, an authorization request for the transaction for purchase of the one or more products from the merchant based on the checkout token and the payment account.

13. The computer-implemented method of claim 12, further comprising transmitting the authorization request to an issuer associated with a payment account of the consumer, as identified in the checkout token.

14. The computer-implemented method of claim 12, further comprising transmitting the authorization request to an acquirer associated with the merchant, as identified by the checkout token.

15. The computer-implemented method of claim 9, further comprising generating an authorization request for the transaction for purchase of the one or more product from the merchant.

16. The computer-implemented method of claim 15, wherein generating the authorization request includes:
receiving the checkout token, from the communication device associated with the consumer, along with a payment account credential associated with the consumer and product purchase information, and
generating the authorization request based on the checkout token, the payment account credential associated with the consumer, and the product purchase information.

17. The computer-implemented method of claim 16, wherein the computer-readable merchant indicator includes one of a quick response (QR) code and a wireless signal indicative of the merchant; and
wherein the product purchase information includes at least one of a product name and a product brand.

18. A system for use in facilitating payment account transactions, the system comprising a person to merchant (P2M) engine configured to:
solicit merchant information for a merchant;
store the merchant information in a data structure associated with the P2M engine, the merchant information including one or more of a name of the merchant, a merchant ID for the merchant, a merchant account number for the merchant, and a merchant address for the merchant;
define a computer-readable merchant indicator including a checkout ID and associated with the merchant, based on the merchant information, whereby consumers are able to initiate payment account transactions with the merchant based on the computer-readable merchant indicator, via communication devices associated with the consumers, apart from providing payment account credential to a point-of-sale (POS) terminal associated with the merchant; and
generate a checkout token, for a transaction to purchase one or more products, when the checkout ID included in the computer-readable merchant indicator is provided from a consumer, the checkout token including and/or associated with the checkout ID and product purchase information associated with the transaction.

19. The system of claim 18, wherein the P2M engine is further configured to:
transmit the checkout token to a communication device associated with the consumer;
receive the checkout token, from the communication device, along with a payment account credential selected by the consumer; and
generate an authorization request based on the checkout token, as received back from the communication device associated with the consumer, and the payment account credential.

20. The system of claim 19, wherein the P2M engine is configured, in connection with generating the checkout token, to store the product purchase information in a data structure in association with the checkout token; and
wherein at least the product purchase information is excluded from the checkout token.
